(19) United States
(12) Patent Application Publication
(10) Pub. No.: US 2026/0116290 A1
(43) Pub. Date: Apr. 30, 2026

(54) PORTABLE FOLDING SAFETY TRIANGLE

(71) Applicant: Min Gyu SHIN, Incheon (KR)

(72) Inventor: Min Gyu SHIN, Incheon (KR)

(21) Appl. No.: 18/960,313

(22) Filed: Nov. 26, 2024

(30) Foreign Application Priority Data
Oct. 29, 2024 (KR) 10-2024-0149971

(51) Int. Cl. B60Q 7/00; G09F 13/16

(52) U.S. Cl. CPC B60Q 7/00; G09F 13/16

(57) ABSTRACT

The present invention relates to a portable folding safety triangle including a main body portion having three bars that are longitudinally formed and have both ends rotatably coupled to each other to have a straight shape due to overlapping each other when the main body portion is folded and to automatically unfold into a triangular shape when the main body portion is unfolded; and a case portion formed to correspond to the shape when the main body portion is folded, provided to have the main body portion inserted thereinto, and in a state in which the main body portion is unfolded, provided to come into contact with any one of the three bars and allow the main body portion to stand.

### CROSS-REFERENCE TO RELATED APPLICATION

This application claims priority to and the benefit of Korean Patent Application No. 10-2024-0149971, filed on Oct. 29, 2024, the disclosure of which is incorporated herein by reference in its entirety.

### BACKGROUND

### 1. Field of the Invention

The present invention relates to a triangle, and more particularly, to a portable folding safety triangle that is provided to unfold automatically and can be stored in a folded state inside a case when folded.

### 2. Discussion of Related Art

Generally, when a vehicle stalls on a road such as a highway due to an accident, a vehicle breakdown, etc., a driver quickly moves the vehicle to a shoulder while checking the surrounding traffic conditions and then installs a safety triangle at the rear of the vehicle to induce drivers of vehicles coming from behind to pay attention to the front, thereby preventing secondary accidents.

In the case of highways, in the event of a secondary accident in which a rear vehicle rear-ends a vehicle in front due to a driver of the vehicle in front not indicating an occurrence of an accident or a breakdown thereof using an obstacle in front such as a triangle, the driver of the vehicle in front is liable for 30 to 40% of civil damages, and if such a secondary accident occurs at night, the liability of the driver of the vehicle in front increases to 50 to 60%.

Conventionally, a folding triangle is kept in a vehicle, and in the event of an accident or breakdown of the vehicle, the triangle is assembled and set up on a road surface at a certain distance behind the vehicle to induce drivers of vehicles coming from behind to pay attention to the front.

In the case of a conventional triangle, since the driver needs to move to a triangle installation position to set up the triangle, an accident in which the driver is hit by a vehicle coming from behind may occur in a process in which the driver moves to the triangle installation position or assembles the triangle, and a case in which the installed triangle gets blown over by the wind and is unable to perform its function properly occurs frequently. In addition, since most triangles are configured to reflect headlights of the vehicles coming from behind and help the drivers of the vehicles coming from behind recognize the triangles through the reflected light instead of being configured to emit light by their own light emitting means, in bad weather such as rainy days or heavy fog, a case in which the drivers of the vehicles coming from behind recognize the reflected light of the triangles late and are unable to properly handle the situation occurs.

In order to address such problems, there is a need for a safety triangle that is portable and can quickly be installed.

### SUMMARY OF THE INVENTION

The present invention is directed to providing a portable folding safety triangle that is portable and can quickly be installed in a case of an accident.

According to an aspect of the present invention, there is provided a portable folding safety triangle including a main body portion having three bars that are longitudinally formed and have both ends rotatably coupled to each other to have a straight shape due to overlapping each other when the main body portion is folded and to automatically unfold into a triangular shape when the main body portion is unfolded; and a case portion formed to correspond to the shape when the main body portion is folded, provided to have the main body portion inserted thereinto, and in a state in which the main body portion is unfolded, provided to come into contact with any one of the three bars and allow the main body portion to stand.

In addition, when the main body portion is folded, the three bars may have a form in which an upper bar, a middle bar, and a lower bar are stacked, and the main body portion may include a spacing portion provided at a coupling site of the upper bar and the lower bar in a stacking direction to connect the upper bar and the lower bar.

In addition, the middle bar may have a portion rotatably coupled in a longitudinal direction, and an elastic body may be inserted into the coupling site so that the middle bar is unfolded.

In addition, in the main body portion, as the middle bar is unfolded by one end of the middle bar being coupled to the upper bar and the other end of the middle bar being coupled to the lower bar, the upper bar and the lower bar may also rotate together.

In addition, the middle bar may have a portion rotatably coupled in the longitudinal direction, the other end of the first bar and one end of the second bar may be rotatably coupled with the elastic body disposed therebetween, one end of the first bar may be rotatably coupled to the upper bar, and the other end of the second bar may be rotatably coupled to the lower bar.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a view for describing an overall appearance of a portable folding safety triangle according to one embodiment of the present invention;

FIG. 2 is a view for describing a main body portion and a case portion of the portable folding safety triangle according to one embodiment of the present invention;

FIG. 3 is a view for describing a state in which the main body portion is folded and inserted into the case portion of the portable folding safety triangle according to one embodiment of the present invention;

FIG. 4 is a view for describing an overall configuration of the portable folding safety triangle according to one embodiment of the present invention;

FIG. 5 is a view for describing an unfolded state of the portable folding safety triangle according to one embodiment of the present invention;

FIG. 6 is a view for describing a spacing portion of the portable folding safety triangle according to one embodiment of the present invention;

FIGS. 7 and 8 are views for describing a configuration provided to allow automatic unfolding of the portable folding safety triangle according to one embodiment of the present invention;

FIG. 9 is a view for describing a stand portion of a portable folding safety triangle according to a modified embodiment of the present invention;

FIG. 10 is a view for describing the stand portion being adhered to a case portion of the portable folding safety triangle according to the modified embodiment of the present invention;

FIG. 11 is a view for describing a portable folding safety triangle according to a second embodiment of the present invention;

FIG. 12 is an exploded view of the portable folding safety triangle according to the second embodiment of the present invention;

FIG. 13 is a view for describing an elastic body of the portable folding safety triangle according to the second embodiment of the present invention;

FIG. 14 is a view for describing a coupling protrusion, a coupling groove, and the elastic body of the portable folding safety triangle according to the second embodiment of the present invention; and

FIGS. 15 and 16 are views for describing a first magnetic body and a second magnetic body of the portable folding safety triangle according to the second embodiment of the present invention.

### DETAILED DESCRIPTION OF EXEMPLARY EMBODIMENTS

Hereinafter, exemplary embodiments according to the present invention will be described in detail with reference to the accompanying drawings.

Advantages and features of the present invention and methods of achieving the same should become clear from embodiments described in detail below with reference to the accompanying drawings.

However, the present invention is not limited to the embodiments disclosed below and may be implemented in various different forms. The present embodiments are only provided to make the disclosure of the present invention complete and completely inform those of ordinary skill in the art to which the present invention pertains of the scope of the invention. The scope of the present invention is only defined by the scope of the claims.

In addition, in describing the present invention, when it is determined that the detailed description of a known related art may obscure the gist of the present invention, the detailed description thereof will be omitted.

The present invention relates to a portable folding safety triangle that mainly includes a main body portion 100 and a case portion 200.

First, the main body portion 100 may be used to inform a driver of a vehicle coming from behind of the fact that a vehicle has stalled due to a breakdown thereof or an emergency situation on a road with normal vehicular traffic.

To this end, the main body portion 100 may be provided in a triangular shape and may be provided in a form in which a reflective plate, a light emitting diode (LED), or the like is inserted into one surface.

In describing the present invention, two different embodiments will be separately described.

### First Embodiment

Since the main body portion 100 has three bars that are longitudinally formed and have ends that can be rotatably coupled to each other, the main body portion 100 can be folded into a longitudinal bar shape when being carried and can automatically unfold into a triangular shape when being used.

Meanwhile, the case portion 200 may be formed to correspond to the shape when the main body portion 100 is folded and may be provided to have the main body portion 100 inserted thereinto, and a stand groove 220 may be formed in a portion of the case portion 200 in a longitudinal direction to allow the main body portion 100 to stand due to any one of the three bars being inserted into the stand groove 220 in a state in which the main body portion 100 is unfolded.

The present invention will be described in detail with reference to the accompanying drawings.

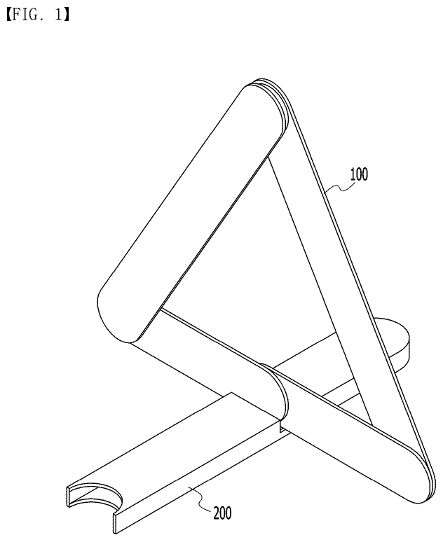

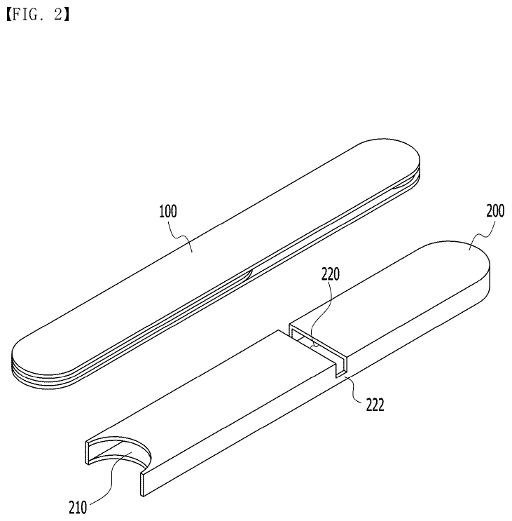

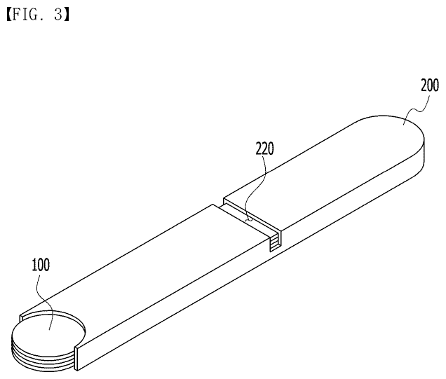

FIG. 1 is a view for describing an overall appearance of a portable folding safety triangle according to a first embodiment of the present invention, FIG. 2 is a view for describing the main body portion 100 and the case portion 200 of the portable folding safety triangle according to the first embodiment of the present invention, and FIG. 3 is a view for describing a state in which the main body portion 100 is folded and inserted into the case portion 200 of the portable folding safety triangle according to the first embodiment of the present invention.

As illustrated, the triangle may have the main body portion 100 that is able to be inserted into the case portion 200 and stand.

To this end, preferably, the bars inserted into the case portion 200 may have a thickness that corresponds to the stand groove 220 of the case portion 200. In the first embodiment of the present invention, the bars may be stacked while overlapping each other when the triangle is folded and may be provided in a triangular shape when the triangle is unfolded.

As illustrated in FIG. 2, the main body portion 100 and the case portion 200 according to the first embodiment of the present invention are placed side by side with each other.

When the main body portion 100 is folded, the three bars may be stacked while overlapping each other, and the lengths and widths of the three bars may be the same. In addition, the case portion 200 may have a size that surrounds the main body portion 100 while having a shape that corresponds to the shape of the main body portion 100.

In addition, it can be seen that the stand groove 220 is formed at a center of one surface of the case portion 200.

As described above, any one of an upper bar 120, a lower bar 160, and a middle bar 140 that constitute the main body portion 100 may be inserted into the stand groove 220, and the stand groove 220 may have a thickness that is the same as or relatively larger than a thickness of any one of the bars 120, 140, and 160 inserted thereinto.

This is to allow the main body portion 100 to stand when the main body portion 100 is inserted into the stand groove 220, and the main body portion 100 may be supported while tilted at a predetermined angle when the stand groove 220 is formed to have a predetermined thickness in a longitudinal direction of the case portion 200, and the predetermined thickness is greater than a thickness of any one of the bars 120, 140, and 160 inserted thereinto.

In addition, the case portion 200 may have a holding groove 210 formed at one end in the longitudinal direction.

First, the case portion 200 may have surface bodies of the same length disposed to be spaced apart from and parallel to each other and may have one end that is open and the other end formed to protrude in a semicircular shape.

This semicircular shape may be the same as a semicircular shape of an end of the main body portion 100 when the main body portion 100 is folded while the bars thereof are stacked, that is, when the main body portion 100 has the shape of a straight line.

In addition, the one end of the case portion 200 at which a holding portion is formed may have a shape that is concave in a semicircular shape that appears as if a circular piece has been removed from the end of the case portion 200.

In other words, the semicircular, concave groove may be formed toward the center in the longitudinal direction by removing a circular shape from a shape that protrudes in a semicircular shape.

This may be to allow the main body portion 100 inserted into the case portion 200 to be quickly taken out of the case portion 200 in the triangle of the present invention that is provided to be portable.

Therefore, a user may, while holding the case portion 200 with one hand, hold the main body portion 100 with the thumb and the index finger of the other hand through the holding groove 210 and take out the main body portion 100 from the case portion 200.

Next, the main body portion 100 will be described.

The main body portion 100 may, when folded, have a shape in which three bars are stacked, and the three bars may include the upper bar 120, the middle bar 140, and the lower bar 160.

In the present embodiment, the upper bar 120 and the lower bar 160 may be provided to have the same shape, and the upper bar and the lower bar may be reversed according to selection of a front surface and a rear surface.

Therefore, the scope of rights is not limited by designating the upper bar 120 and the lower bar 160 according to the first embodiment of the present invention, and as described above, the upper bar 120 and the lower bar 160 may have the same shape and may replace each other.

In the present invention, when the main body portion 100 is folded, the shape of the main body portion 100 may be changed to a straight shape as a first bar 142 and a second bar 144 move toward a coupling site at which the upper bar 120 and the lower bar 160 are coupled, and at a portion where the first bar 142 and the second bar 144 are coupled, one surface of the first bar overlaps one surface of the upper bar 120 to come into contact therewith, the other surface of the first bar 142 overlaps one surface of the second bar 144, and the other surface of the second bar 144 overlaps one surface of the lower bar 160.

The triangle according to the first embodiment of the present invention will be described in detail below with reference to subsequent drawings.

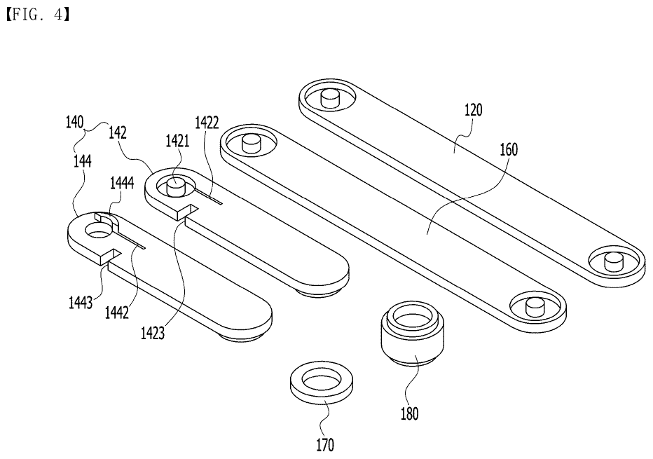

FIGS. 4 to 8 are views for describing the main body portion 100.

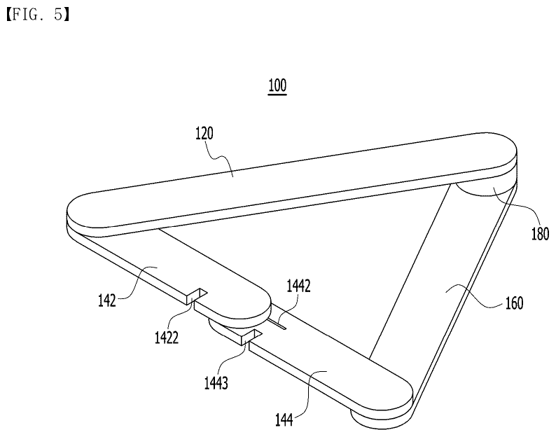

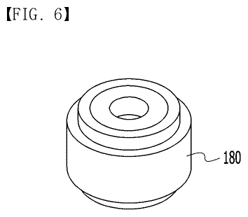

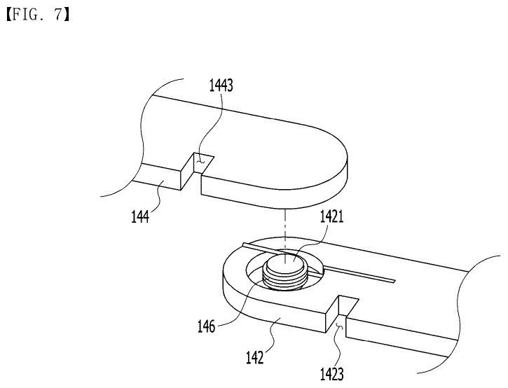

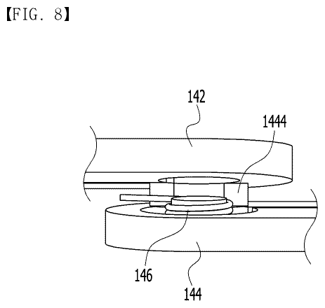

FIG. 4 is a view for describing an overall configuration of the portable folding safety triangle according to the first embodiment of the present invention, FIG. 5 is a view for describing an unfolded state of the portable folding safety triangle according to the first embodiment of the present invention, FIG. 6 is a view for describing a spacing portion 180 of the portable folding safety triangle according to the first embodiment of the present invention, and FIGS. 7 and 8 are views for describing a configuration provided to allow automatic unfolding of the portable folding safety triangle according to the first embodiment of the present invention.

First, the main body portion 100 will be described with reference to FIG. 4. FIG. 4 is an exploded view of the main body portion 100.

As illustrated, the main body portion 100 may be configured to include the upper bar 120, the lower bar 160, the middle bar 140, a bearing portion 170, and the spacing portion 180.

In the illustrated drawing, the two bars that are formed to be relatively long are the upper bar 120 and the lower bar 160, and the bar formed to have a relatively short length is the middle bar 140.

The upper bar 120, the lower bar 160, and the middle bar 140 which includes the first bar 142 and the second bar 144 may be arranged in this order from an outermost upper portion to a lower portion.

The upper bar 120 and the lower bar 160 may be formed to be long and may have the same width and length.

In addition, both ends of the upper bar 120 and the lower bar 160 may serve as coupling sites at which the upper bar 120 and the lower bar 160 are coupled to each other, and the coupling sites may have the shape of a protrusion (no reference numeral) formed to protrude a predetermined distance from a center of a circular groove (no reference numeral).

The spacing portion 180 may be disposed at the coupling sites of the upper bar 120 and the lower bar 160, and the upper bar 120 and the lower bar 160 may be coupled with the spacing portion 180 disposed therebetween.

The spacing portion 180 may be provided at the coupling sites, where the upper bar 120 and the lower bar 160 are coupled to each other, to enable each of the upper bar 120 and the lower bar 160 to rotate, and the spacing portion 180 may be provided to have a thickness that corresponds to a thickness of the middle bar 140.

According to the first embodiment of the present invention, coupling sites of the upper bar 120, the lower bar 160, and the middle bar 140 are provided to overlap each other, and the coupling sites of the upper bar 120 and the lower bar 160 are spaced apart at a distance that corresponds to the thickness of the middle bar 140, and thus the spacing portion 180 may be inserted.

Here, the spacing portion 180 may have both sides provided in the form of a bearing in a stacking direction.

This may be to reduce friction in a form in which the upper bar 120 and the lower bar 160 are folded or unfolded.

Meanwhile, the middle bar 140 may include the first bar 142 and the second bar 144, a coupling site at which the first bar 142 and the second bar 144 are coupled to each other may have a shape in which the first bar 142 and the second bar 144 are stacked while ends thereof overlap each other, and an elastic body 146 may be disposed in the middle bar 140.

The elastic body 146 according to the first embodiment of the present invention may be provided in the form of a torsion spring, and both ends of the elastic body 146 may have the first bar 142 and the second bar 144 bound thereto to return the first bar 142 and the second bar 144 to their initial positions in response to torsional stress.

At this time, the initial positions may refer to a state in which the first bar 142 and the second bar 144 are arranged in a straight line and returned to constitute a triangular shape in conjunction with the upper bar 120 and the lower bar 160 connected to the middle bar 140.

Here, the elastic body 146 may be disposed between the first bar 142 and the second bar 144, and the first bar 142 and the second bar 144 may be bound to portions protruding from both ends of the elastic body 146.

To this end, a first fixing groove 1422 of the elastic body 146 may be formed in the first bar 142, and a second fixing groove 1442 of the elastic body 146 may be formed in the second bar 144. The first fixing groove 1422 of the elastic body 146 and the second fixing groove 1442 of the elastic body 146 may each have the shape of an engraved groove and correspond to the size and length of both ends of the elastic body 146.

In addition, the elastic body 146 may be prevented from being detached when the first bar 142 and the second bar 144 are coupled to each other.

The coupling site at which the first bar 142 and the second bar 144 are coupled to each other may have a form in which a rotary protrusion 1421 formed on the first bar 142 is coupled to a groove formed in the second bar 144, and a guide protrusion 1444 of the elastic body 146 that can fix the position of a body of the elastic body 146 to prevent the elastic body 146 from rotating together when the first bar 142 and the second bar 144 rotate may be further included in the groove of the second bar 144.

The guide protrusion 1444 of the elastic body 146 may have a curvature and be formed in a bent shape to come into contact with the elastic body 146 and limit movement of at least one of both ends of the elastic body 146.

Therefore, the elastic body 146 may move the first bar 142 and the second bar 144 to their initial positions.

Meanwhile, as illustrated, a groove may be concavely formed in a width direction in each of the first bar 142 and the second bar 144.

This may be to provide a supporting force for fixing the middle bar 140 to the case to allow the middle bar 140 to stand.

Specifically, the first fixing groove 1422 of the elastic body 146 may be formed in the first bar 142, the second fixing groove 1442 of the elastic body 146 may be formed in the second bar 144, and when the middle bar 140 is fixed to the case, the middle bar 140 may be inserted into sidewalls 222 formed at both sides in a width direction of the case at the stand groove 220 and a position at which the middle bar 140 is inserted into the stand groove 220 of the case.

With the above configuration, the portable folding safety triangle of the present invention may allow the shape of the main body portion 100 to be changed to a triangular shape by the first bar 142 and the second bar 144 unfolding due to the elastic body 146 and the upper bar 120 and the lower bar 160 also unfolding together as a result.

Meanwhile, the portable folding safety triangle according to a modified embodiment of the present invention may include a stand portion 300.

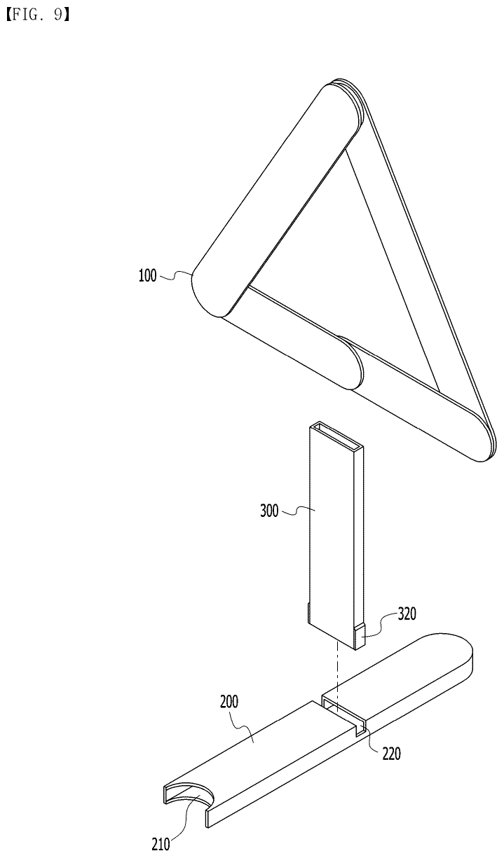

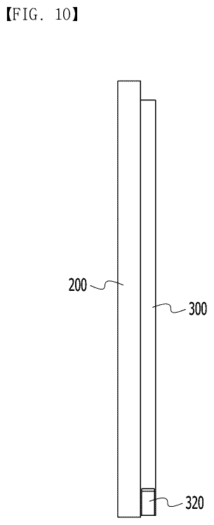

FIG. 9 is a view for describing a stand portion of a portable folding safety triangle according to a modified embodiment of the present invention, and FIG. 10 is a view for describing the stand portion being adhered to the case portion 200 of the portable folding safety triangle according to the modified embodiment of the present invention.

As illustrated, it can be seen that the stand portion 300 is disposed between the main body portion 100 and the case portion 200.

The stand portion 300 may have a rectangular parallelepiped shape that is formed to be long and may have an upper portion inserted into a first insertion groove 1423 and a second insertion groove 1443 and a lower portion inserted into the stand groove 220.

This is to allow the main body portion 100 to stand upward, and to this end, side covers 320 may be further included at a lower portion of the stand portion 300 to allow the stand portion 300 to be inserted into the stand groove 220.

The side covers 320 may be formed at positions corresponding to the stand groove 220 and may be formed at both sides of the stand portion 300 in a width direction thereof.

The side covers 320 may protrude from side surfaces of the stand portion 300 and allow a space to be formed between the side surfaces of the stand portion 300, and the sidewalls 222 may be inserted into the side covers 320.

Therefore, the side covers 320 may have a tapered form in which a gap therebetween gradually increases downward in an up-down direction of the side surfaces of the stand portion 300 so that the size of the space gradually increases from an upper portion toward a lower portion.

This is because when the sidewalls 222 are inserted into the side covers 320, a binding force may increase as the space gradually narrows.

In addition, the stand portion 300 may be formed in a telescopic form so that a length thereof may increase in a longitudinal direction.

In addition, the stand portion 300 may be detachably adhered to one surface of the case portion 200 to maintain surface contact with the case portion 200.

To this end, the stand portion 300 and the case portion 200 may be adhered to each other by a hook-and-loop fastener or adhered to each other by a magnet.

To this end, a magnetic body may be embedded in the stand portion 300 and the case portion 200.

### Second Embodiment

A portable folding safety triangle according to a second embodiment of the present invention is the same as the portable folding safety triangle according to the first embodiment of the present invention in that a main body portion 100 includes an upper bar 120, a lower bar 160, and a middle bar 140, and the middle bar 140 includes a first bar 142 and a second bar 144, and thus descriptions thereof will be omitted.

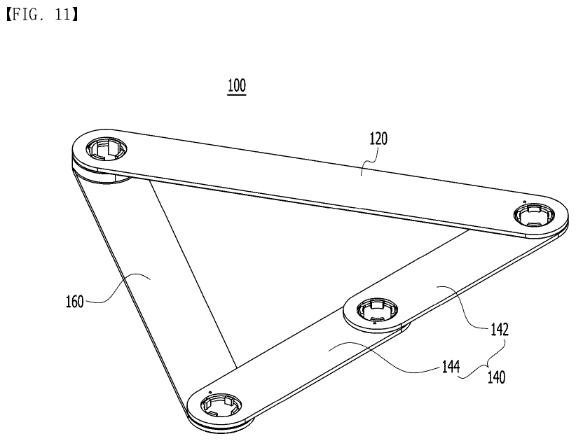

The second embodiment will be described with reference to FIGS. 11 to 16.

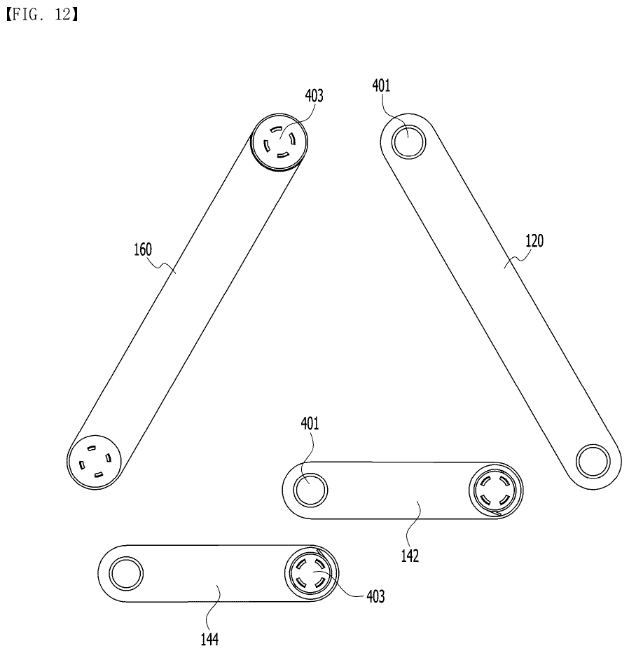

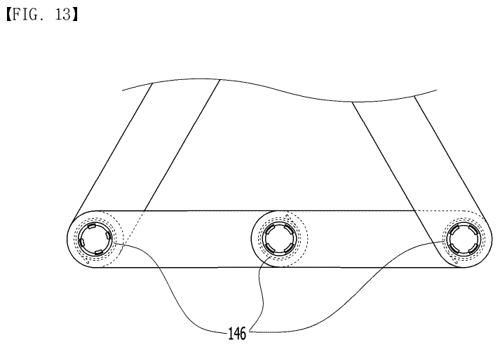

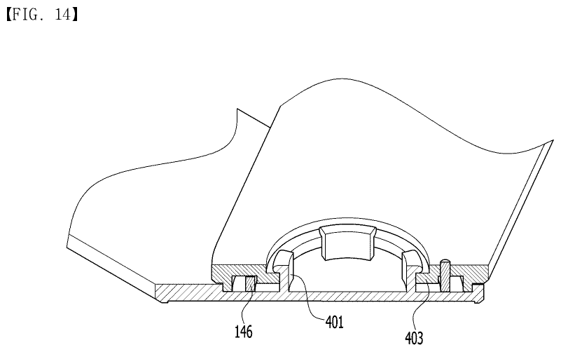

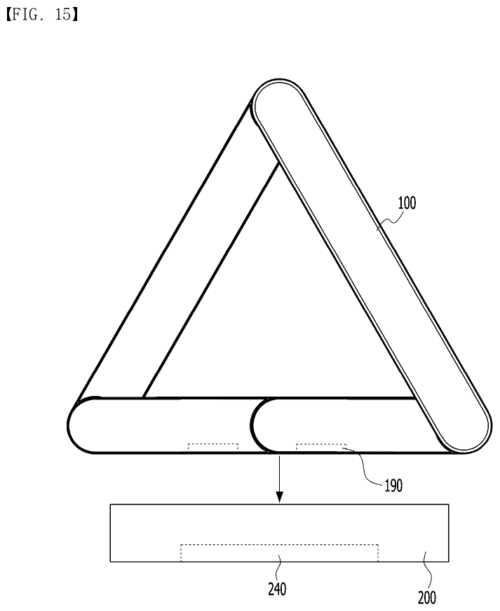

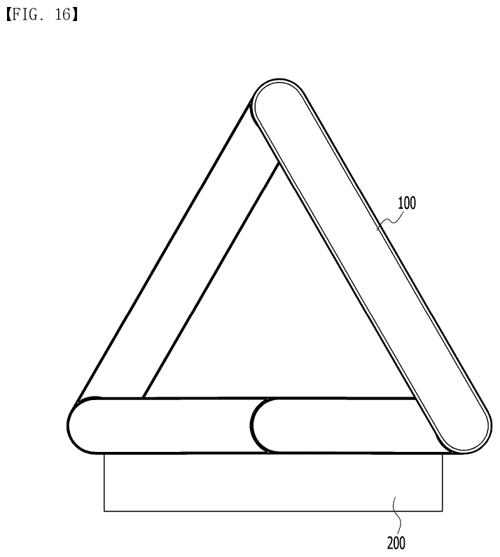

FIG. 11 is a view for describing a portable folding safety triangle according to a second embodiment of the present invention, FIG. 12 is an exploded view of the portable folding safety triangle according to the second embodiment of the present invention, FIG. 13 is a view for describing an elastic body 146 of the portable folding safety triangle according to the second embodiment of the present invention, FIG. 14 is a view for describing a coupling protrusion 401, a coupling groove 403, and the elastic body 146 of the portable folding safety triangle according to the second embodiment of the present invention, and FIGS. 15 and 16 are views for describing a first magnetic body 190 and a second magnetic body 240 of the portable folding safety triangle according to the second embodiment of the present invention.

As illustrated, it can be seen that coupling grooves 403 having a through-form are formed at both ends of the upper bar 120, and coupling protrusions 401 are formed at both ends of the lower bar 160 to allow the coupling grooves 403 to be bound thereto.

At this time, the coupling protrusions 401 of the lower bar 160 may protrude toward the same plane.

The first bar 142 and the second bar 144 may each have the coupling protrusion 401 and the coupling groove 403 formed at both ends.

Referring to FIG. 12, the coupling grooves 403 are formed at both ends of the upper bar 120, and the coupling protrusions 401 are formed at both ends of the lower bar 160. The coupling protrusions 401 formed on the lower bar 160 may be formed to protrude toward the same plane and may be a plurality of protrusions arranged at predetermined intervals.

According to the second embodiment of the present invention, four coupling protrusions 401 may be provided, and the four coupling protrusions 401 may each be formed to be bent at a predetermined angle and may be spaced apart at predetermined intervals.

In addition, the coupling protrusions 401 that are longitudinally formed to have a predetermined length and are bent may be symmetrically formed at positions facing each other, and the coupling protrusions 401 adjacent thereto may also be formed in this manner.

In addition, the coupling protrusions 401 each have an upper end bent outward. Moreover, the bent ends may be formed to be round.

The four coupling protrusions 401 may be arranged in a circular shape.

The coupling grooves 403 coupled to the coupling protrusions 401 may be formed to be penetrated in a circular shape. In this way, the coupling protrusions 401 may be fitted and coupled to the coupling grooves 403, the ends of the coupling protrusions 401 may be formed to be round and facilitate fitting, and coupling may be firmly maintained at coupling sites due to the ends being bent outward in a state in which the coupling protrusions 401 are fitted.

The first bar 142 and the second bar 144 of the middle bar 140 may have the same shapes.

Referring to FIG. 12, it can be seen that at a portion where the first bar 142 and the second bar 144 are coupled, the coupling groove 403 is formed in the first bar 142, and the coupling protrusion 401 is formed on the second bar 144.

The opposite portion is formed in a different shape, and at the coupling site of the first bar 142 and the second bar 144, the first bar 142 having the coupling groove 403 formed at one end may have the coupling protrusion 401 formed at the other end, and the second bar 144 may have the coupling groove 403 formed therein.

With such a structure, the other end of the first bar 142 may be coupled to the upper bar 120, and the other end of the second bar 144 may be coupled to the lower bar 160.

Meanwhile, the elastic body 146 according to the second embodiment of the present invention may be provided as three elastic bodies 146 to guide the main body portion 100 to return to its initial position.

As illustrated in FIG. 13, it can be seen that in a direction from a left side toward a right side, the elastic body 146 is coupled to each of a coupling site of the second bar 144 and the lower bar 160, a coupling site where the second bar 144 and the first bar 142 are coupled, and a coupling site where the first bar 142 and the upper bar 120 are coupled.

The elastic bodies 146 may each have a shape in which a spring is wound and may each have one end protruding upward and coupled to a bar disposed at an upper portion and the other end restrained by a bar disposed at a lower portion in the longitudinal direction to provide a force changing the positions of the bars to the initial positions at which the bars disposed at the upper and lower portions constitute a triangular shape by unfolding from a state in which the bars overlap each other.

At this time, the elastic bodies 146 may each have one end on which a protrusion is formed upward to be coupled to the bar disposed at the upper portion and the other end having an end fixed by the bar disposed at the lower portion.

Specifically, the other end of the elastic body 146 may have a form inserted along the circumference of the coupling protrusion 401, and at this time, as the coupling groove 403 is coupled to the coupling protrusion 401, the elastic body 146 may be prevented from being detached.

The positions of the bar disposed at the upper portion and the bar disposed at the lower portion, which are described herein, may be reversed, and this means that the upper portion may be changed to the lower portion, and the lower portion may be changed to the upper portion. However, the form in which the elastic body 146 is inserted to surround the coupling protrusion 401 may not change.

Meanwhile, a magnetic body may be provided in the portable folding safety triangle according to the second embodiment of the present invention.

The case portion 200 may have a magnetic body embedded therein, may be coated with a magnetic substance, or may be partially formed of a magnetic material through double injection.

In addition, the first bar 142 and the second bar 144 may also have a magnetic body buried therein, formed by double injection, or coated thereon so that the first bar 142 and the second bar 144 may be adhered to one surface of the case portion 200 by a magnetic force.

As illustrated in FIGS. 15 and 16, the second magnetic body 240 may be formed in a portion of the case portion 200 in the longitudinal direction thereof, and the first magnetic body 190 may be formed in each of the first bar 142 and the second bar 144.

In this way, the first magnetic bodies 190 of the first bar 142 and the second bar 144 may be adhered to the second magnetic body 240 of the case, and the main body portion 100 may remain standing.

At this time, the first magnetic bodies 190 may be formed at a lower portion when the main body portion 100 is standing and may be formed at portions far from the upper bar 120 in a width direction of the first bar 142 and the second bar 144, and the case portion 200 may have the second magnetic body 240 formed on any one of the two surfaces disposed parallel to each other!

Here, predetermined grooves may be concavely formed in portions of the case portion 200 in which the second magnetic body 240 is formed, and the predetermined grooves may guide positions at which the first bar 142 and the second bar 144 are inserted.

A triangle of the present invention can be quickly installed.

In addition, the triangle of the present invention can be folded.

Moreover, it is easy to store the triangle of the present invention because it is possible to insert the triangle into a case when the triangle is folded.

In addition, the triangle of the present invention can unfold automatically.

Further, the triangle of the present invention can easily be set up to stand.

Specific embodiments of the portable folding safety triangle according to the present invention have been described above, but it should be apparent that various modifications are possible within a scope not departing from the scope of the present invention.

Therefore, the scope of the present invention should not be defined as being limited to the embodiments described herein and should be defined not only by the claims below but also by their equivalents.

That is, the embodiments described above should be understood as being illustrative, instead of limiting, in all aspects, the scope of the present invention is shown by the claims below rather than by the detailed description provided above, and all changes or modifications derived from the meaning and scope of the claims and their equivalent concepts should be construed as being included in the scope of the present invention.

What is claimed is:

1. A portable folding safety triangle comprising:
a main body portion having three bars that are longitudinally formed and have both ends rotatably coupled to each other to have a straight shape due to overlapping each other when the main body portion is folded and to automatically unfold into a triangular shape when the main body portion is unfolded; and
a case portion formed to correspond to the shape when the main body portion is folded, provided to have the main body portion inserted thereinto, and in a state in which the main body portion is unfolded, provided to come into contact with any one of the three bars and allow the main body portion to stand.

2. The portable folding safety triangle of claim 1, wherein, when the main body portion is folded, the three bars have a form in which an upper bar, a middle bar, and a lower bar are stacked, and the main body portion includes a spacing portion provided at a coupling site of the upper bar and the lower bar in a stacking direction to connect the upper bar and the lower bar.

3. The portable folding safety triangle of claim 2, wherein the middle bar has a portion rotatably coupled in a longitudinal direction, and an elastic body is inserted into the coupling site so that the middle bar is unfolded.

4. The portable folding safety triangle of claim 3, wherein, in the main body portion, as the middle bar is unfolded by one end of the middle bar being coupled to the upper bar and the other end of the middle bar being coupled to the lower bar, the upper bar and the lower bar also rotate together.

5. The portable folding safety triangle of claim 4, wherein the middle bar has a portion rotatably coupled in the longitudinal direction, the other end of the first bar and one end of the second bar are rotatably coupled with the elastic body disposed therebetween, one end of the first bar is rotatably coupled to the upper bar, and the other end of the second bar is rotatably coupled to the lower bar.
